(19) United States
(12) Patent Application Publication
(10) Pub. No.: US 2002/0077868 A1
(43) Pub. Date: Jun. 20, 2002

(54) Insurance method

(76) Inventor: Jean-Charles Javerlhac, Guimps (FR)

Correspondence Address: OLIFF & BERRIDGE, PLC, P.O. BOX 19928, ALEXANDRIA, VA, 22320, US

(21) Appl. No.: 09/798,988

(22) Filed: Mar. 6, 2001

Related U.S. Application Data
(63) Continuation-in-part of application No. 09/735,908, filed on Dec. 14, 2000.
(63) Continuation-in-part of application No. 09/739,771, filed on Dec. 20, 2000.

(51) Int. Cl. G06F 17/60

(52) U.S. Cl. 705/4

(57) ABSTRACT

An insurance method comprising the following steps:

establishing a contract between a client to be insured and an insurer ready to insure the client against possible claims, in which contract the client pays the insurer an initial sum covering at least the costs of insurance over a predetermined duration;

investing at least a portion of said initial sum so that the invested sum earns income; and

at the end of the said predetermined duration, reimbursing the client with a sum that is a function of the income earned by the investment made by the insurer and of the claims the insurer has had to indemnify during said predetermined duration.

The present invention relates to an insurance method intended particularly, but not exclusively, to indemnify damage caused to a third party or damage suffered by one's own property.

The invention also relates to a method of selling or renting a vehicle.

The invention also relates to a method for selling or renting a good, with establishing an extension of warranty concerning hidden defects.

The invention also relates to a method of reinsurance.

Insurance policies are contracts established for determined durations, possibly with tacit renewal.

In conventional insurance policies, the initial sum or premium paid by the client to the insurer corresponds solely to the costs of insurance, i.e. to the amount the insurer demands in order to cover the risks during the period of the contract, generally one year.

There exists a need to make clients more loyal and to make them participate in reducing the risks to which the insurer is exposed.

The invention seeks specifically to satisfy this need, and it achieves this by a novel insurance method comprising the following steps:

establishing a contract between a client to be insured and an insurer ready to insure the client against possible claims, in which contract the client pays the insurer an initial sum covering at least the costs of insurance over a predetermined duration;

investing at least a portion of said initial sum so that the invested sum earns income; and

at the end of the said predetermined duration, reimbursing the client with a sum that is a function of the income earned by the investment made by the insurer and of the claims the insurer has had to indemnify during said predetermined duration.

By means of the invention, throughout the duration during which the client is insured, at least a portion of the sum paid by the client to the insurer on signing the contract can be earning income that can benefit the client.

For the insurer, this method of insurance has the advantage of increasing available cash, of making clients participate in reducing the risks and of making clients more loyal.

For clients, this method of insurance presents the advantage of enabling them to build up capital by means of the premiums that they would have to pay in any case.

In an aspect of the insurance, the sum reimbursed to the client corresponds, at least if there is no claim, at least to a major fraction of the income earned by the investment.

In an aspect of the invention, the sum reimbursed to the client corresponds to all of the income earned by the investment.

In an aspect of the invention, the investment is at a guaranteed minimum rate, which rate may be fixed or variable.

In an aspect of the invention, the client is given the option of signing an addition to the contract while it is in force to enable the client to pay in an additional sum in the event of the insured risk increasing.

In an aspect of the invention, the client is given the option of signing an addition to the contract while it is in force to enable the client to withdraw a sum in the event of the risk decreasing.

In an aspect of the invention, the predetermined duration is longer than a determined duration set by legislation and enabling a tax advantage to be obtained.

In an aspect of the invention, the reimbursement is made in the form of a lump sum.

In an aspect of the invention, the reimbursement is made in the form of an annuity.

In an aspect of the invention, the risks covered by the insurer concern property selected from the following list: vehicles, in particular cars, belonging to or used by the client; boats; other leisure property, real property belonging to the client and/or occupied by the client; professional property.

In addition to risks mentioned above, the risks covered can concern defects of operation of a good, in particular an automobile, an industrial good or a domestic appliance, the insurance contract being a warranty contract covering hidden defects.

In an aspect of the invention, the initial sum paid by the client is greater than the total of the premiums paid in advance.

In another aspect of the invention, the initial sum paid by the client is less than the total of the premiums due during the period of the contract, with at least a fraction of the earnings being used to pay at least a fraction of the premiums.

In an aspect of the invention, the duration of the contract is longer than one year, and preferably longer than or equal to three years.

In an aspect of the invention, the client is given the option of a plurality of contract durations, long duration contracts being more advantageous than short duration contracts in terms of the returns that can be obtained.

For example, by extending the contract in time, the client can capitalize and thus build up additional retirement pension.

In an aspect of the invention, at the end of a long-term contract, e.g. of term greater than or equal to five years, the insurer can return the entire initial sum to the client plus the income earned by the investment made by the insurer, which amounts to making a present of at least a portion of the insurance costs, for example in order to thank a client who is particularly loyal, who is to be privileged, or who is about to retire, and who has not made any claims.

The invention also provides a method of insuring apparatus for locomotion on land, air, or sea, comprising the following steps:

a) paying to the insurer in addition to the purchase or rental of the vehicle, a sum that is greater than or equal to the cost of insurance during a predetermined period;

b) investing at least a fraction of the sum paid by the client in an investment selected so that the income earned by the investment compensates for the cost of insurance in the absence of a claim; and

c) returning to the client, in the absence of a claim, and at the end of said predetermined period, at least said initial sum.

Thus, a car manufacturer acting as an insurer, or an insurer, can offer car insurance to a client at zero cost, which is particularly attractive commercially speaking.

If allowed under tax legislation, at least a portion of the initial sum paid by the client to the insurer is deducted from the amount of VAT due for the purchase of the vehicle, and at least a portion of the income earned by the investment is for obtaining an additional retirement pension.

The invention also provides for a method of selling or renting a good, with establishing an extension of warranty, comprising

a) paying an initial sum corresponding at least in part to an extension for a predetermided period of the warranty covering the good purchased or rented by a client,

b) investing at least part of the initial sum during said predetermined period so as it provides benefit,

c) at the end of said predetermined period, in the absence of claim of the warranty, returning the client at least a part of the initial sum.

The sum returned to the client can be for example in the form of a coupon to be given when purchasing a new good or in the form of an offer to extend the duration of the warranty for a new good to be purchased or rented.

The invention also provides a system for issuing an insurance policy, comprising:

means for inputting the duration of the contract;

means for inputting the nature of the property to be insured;

means for calculating, where appropriate, the total of the premiums due during the duration of the contract, as a function of the nature of the property to be insured;

means for inputting the amount of an initial sum paid by a client;

means for delivering information relating to the earnings that can be made to the advantage of the client by an investment relating to at least a fraction of the initial sum and made by the insurer; and

means for printing an insurance policy including at least the duration of the contract, the amount of the initial sum paid by the client, the nature of the property, and information relating to the income that can be earned by said investment.

The invention also provides an insurance policy comprising:

a contract duration;

the amount of an initial sum paid by the client;

the nature of the property insured; and

information relating to the income that can be earned to the benefit of the client by an investment relating to at least a fraction of the initial sum paid by the client.

Other characteristics and advantages of the present invention will appear on reading the following detailed description of non-limiting implementations of the invention, and on examining the accompanying drawings, in which:

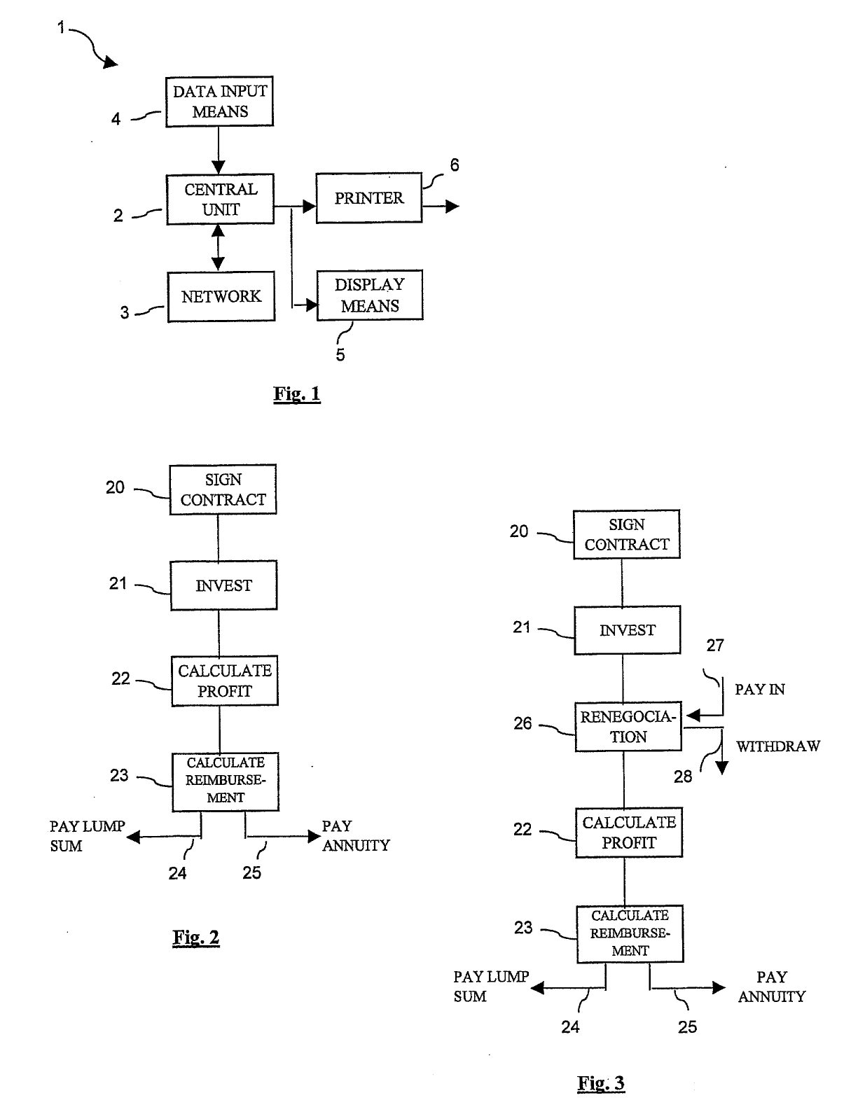

FIG. 1 is a diagrammatic view showing an example of apparatus for issuing an insurance policy;

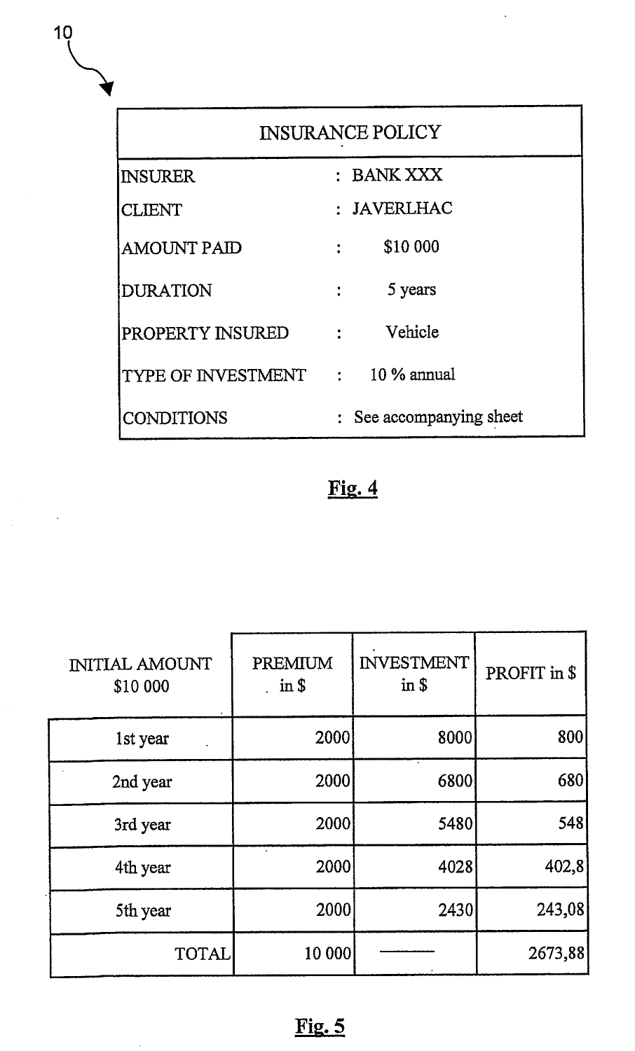

FIG. 2 is a block diagram showing a first example of the insurance method of the invention;

FIG. 3 is a block diagram showing a second example of the insurance method of the invention;

FIG. 4 shows an outline of an insurance policy;

FIG. 5 shows how the earnings from the sums invested by the insurer are calculated;

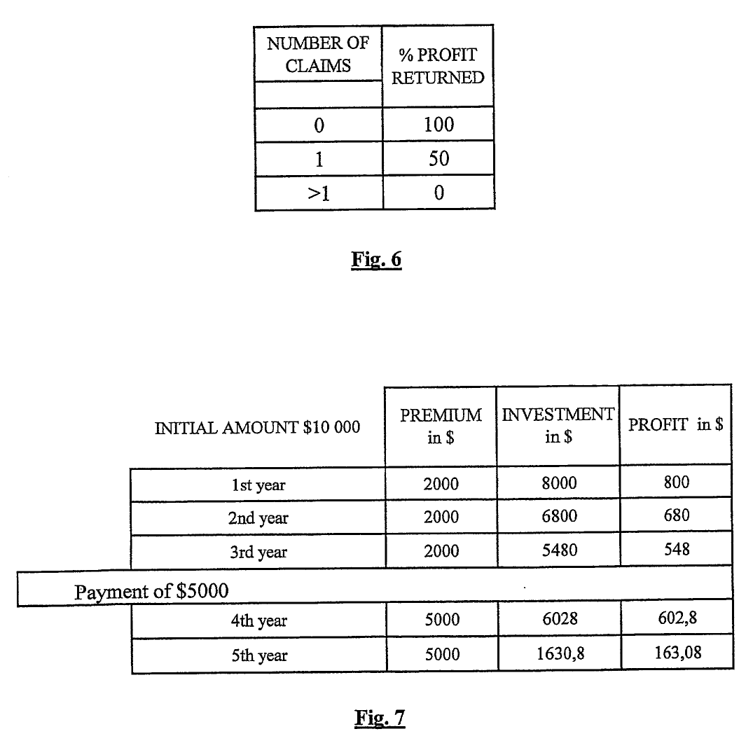

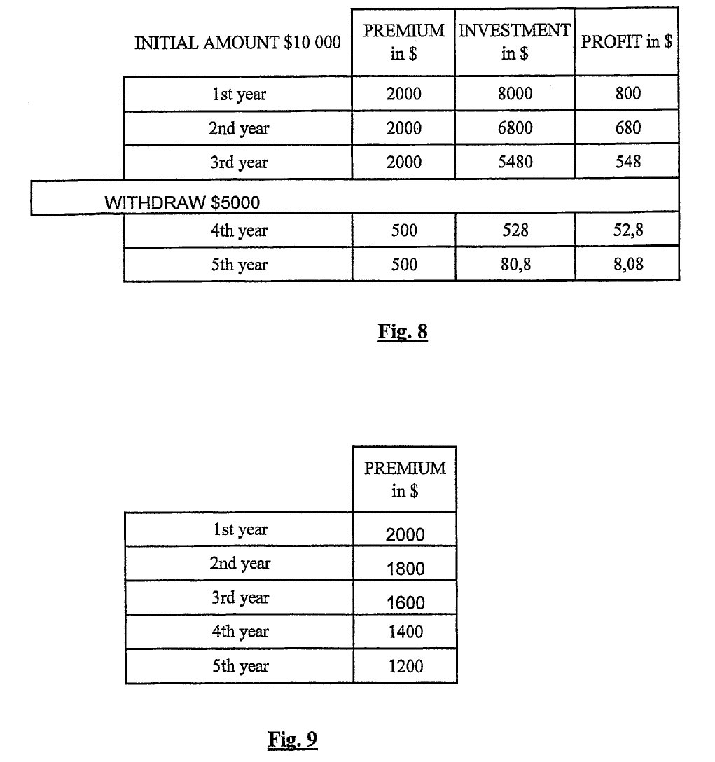

FIG. 6 is an example of a table for determining the sum to be returned to the client;

FIG. 7 is another example of a table for calculating earnings, with capital being added during the contract;

FIG. 8 is another example of a table for calculating earnings, with a withdrawal during the contract;

FIG. 9 is a table showing how the amount due for the annual premiums varies;

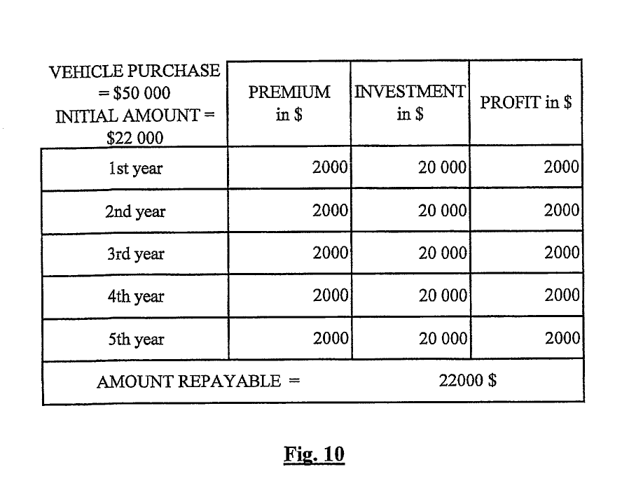

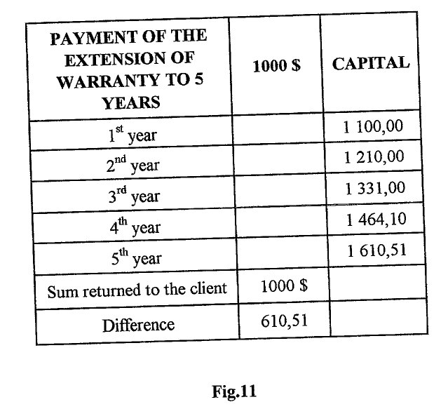

FIG. 10 is a table showing a method of car insurance at zero cost for the car owner, and

FIG. 11 is a table showing a method of insurance covering hidden defects.

FIG. 1 shows apparatus 1 for issuing an insurance policy and comprising: data processor means 2, e.g. constituted by the central unit of a personal computer and having an interface for communication with a computer network 3, e.g. an Intranet interconnecting the agencies of the insurer, data input means 4 such as a keyboard, a mouse, or a touch-sensitive screen, display means 5 such as a cathode ray tube or a liquid crystal screen, and a printer 6, e.g. a dot matrix, ink jet, or laser printer.

The central unit 2 can be programmed to process data input by means of the keyboard 4, and additionally or in a variant, to send data over the network 3, and optionally to receive the results of processing performed remotely.

The apparatus 1 serves to issue an insurance policy 10 of the kind shown in outline in FIG. 4.

Such an insurance policy 10 comprises in particular the name of the insurer with whom the client is making a contract, which insurer can be a bank or an insurance company, the name or the number of the client, the initial amount paid by the client, the duration of the contract, the kind of property insured, and the type of investment performed by the insurer or some analogous information, as described in greater detail below.

The insurance policy 10 can also refer to an accompanying sheet that sets out the general conditions of insurance, in particular the conditions under which capital is paid back at the end of the contract.

Implementation of the insurance method of the invention is described below with reference to FIG. 2.

In an initial step 20, the client makes a contract with the insurer and the insurer uses the above-described apparatus 1 to issue the insurance policy 10.

On signing the contract, the client pays an initial amount to the insurer, e.g. $10,000 in the example described, with the duration of the contract being five years for example and the insured property being a vehicle, for example.

The following step 21 of the method consists in the insurer investing a portion of the amount paid by the client so that it earns money, optionally at greater or lesser risk, depending on the nature of the medium in which the funds are invested.

By way of example, the money can be invested in treasury bonds that provide predetermined return at low risk, in obligations, in convertible obligations, on the share market, in mutual funds, and in particular in those made available by the insurer or an associated organization.

In the example described, in order to simplify the description, it is assumed that the investment produces annual income of 10% on the sums invested, and that the duration of the contract is equal to five years.

In this example, it is also assumed that the amount of the annual premium is $2,000.

The amount invested in the first year is thus $10,000−$2,000=$8,000 which provides income of $800, as shown in the table of FIG. 5, thereby raising the capital to $8,800.

The following year, $2,000 are taken from the $8,800 to pay the premium for the second year.

The remainder, i.e. $6,800 is invested and produces income of $680.

The results of the calculation for the third, fourth, and fifth years are given in the table of FIG. 5.

At step 22 of the method shown in FIG. 2, the total income earned by the investment is calculated for return to the client.

In the example described, the investment has earned $2,673.88.

In step 23, the amount actually returned to the client is calculated as a function of the number of claims that occurred during the contract.

By way of example, this calculation can be performed as shown in the table of FIG. 6, i.e. in the absence of any claim, 100% of the earnings is returned to the client, if the insurer has had to indemnify only one claim, then 50% of the earnings is returned, and if the number of claims is greater, then all of the earnings goes to the insurer.

The sum to be returned to the client can be paid in the form of a lump sum 24 or in the form of an annuity 25.

The method of FIG. 3 differs from that of FIG. 2 by the fact that the contract is renegotiated before it expires in a step 26 so as to enable the client to pay money in 27 or to withdraw money 28.

A payment 27 can be necessary, for example, when the client seeks to insure additional property, such that the premium increases.

By way of example, the table of FIG. 7 corresponds to the case where an exceptional payment of $5,000 is made by the client at the end of the third year to cover an increase in the annual premium from $2,000 to $5,000 so as to insure both a vehicle and a house, for example, instead of only a vehicle.

The opposite case can also arise, e.g. when the risk is decreased because the nature of the property insured changes and gives rise to a decrease in the annual premium.

By way of example, the table of FIG. 8 shows the case where the client withdraws $5,000 at the end of the third year, which withdrawal is made possible because the premium drops from $2,000 to $500, for example because the property now insured is a vehicle of smaller cylinder capacity.

The annual premium can be constant over the duration of the contract or it can vary, for example because of a claim that arises during the contract or on the contrary because no claim arises.

By way of example, FIG. 9 shows the case where the annual premium decreases because the vehicle driver is not involved in any accident.

The amount paid initially by the client can exceed mere payment in advance of the premiums over the period of the contract.

Thus, for example, in the case shown in FIG. 5, the initial amount paid by the client could be greater than $10,000, which amount would then comprise a fraction for paying the insurance premiums over the period of the contract, i.e. $10,000, and an excess for investment by the insurer and to be paid back at the end of the contract however many claims might arise.

When this is possible, the duration of the contract is advantageously selected to be longer than some minimum duration imposed by legislation opening the right to benefit from tax advantages.

Thus, in France, the duration of the contract can be longer than eight years, so as to allow the client to take advantage of a tax exemption on the income earned by the investment made by the insurer.

At the end of the contract, the sum can be paid back to the client or optionally, if allowable under the legislation, to a person other than the client and as specified by the client, without incurring tax.

The invention also makes it possible to insure a motor vehicle at zero costs for the motorist.

By way of example, assume that a motorist purchases a vehicle for $50,000 and pays the insurer, or the car manufacturer if acting as an insurer, the sum of $22,000, where the insurance premium is $2,000.

Each year, $20,000 are invested and it is assumed that they return 10%, i.e. $2,000, thus enabling the insurance premium to be paid.

It will thus be understood, as shown in the table of FIG. 10, that the motorist, in the absence of any claim, and after five years for example, will be able to recover the initial amount in full, i.e. $22,000.

In other words, the vehicle insurance would have been financed by the interest produced by the investment made by the insurer. This sum paid back to the motorist can be reinvested where appropriate in the purchase of a new vehicle, possibly less expensive than the first, with the sum paid back to the client possibly, in the limit, paying for the new vehicle in full.

In one implementation of the invention, tax legislation enables a client to be exonerated from paying the value-added tax (VAT) due for purchasing the vehicle providing the client pays a corresponding sum to the insurer, with the insurer being responsible for investing said sum and returning it to the client after a predetermined duration in the form of an additional retirement pension, e.g. pension capital or an annuity.

In a particular implementation of the invention, provision can also be made for the client to recover the earnings of the investment made by the insurer in the absence of any claim on retirement only.

The invention also applies to reinsurance where the “client” is then constituted by an insurance company seeking to reinsure with another insurance company.

The invention applies to contracts for extending the warranty, which are in some manner insurances covering the defects of operation and more generally all hidden defects. In particular, the invention applies to contracts for extending the warranty agreed during the purchase or rent of goods such as cars, industrial goods or domestic appliances.

Today, to the knowledge of the applicant, the sums paid to retailers, manufacturers or agents for an extension of the warranty from two to five years for example, do not give vent to a refund to the client in the absence of a defect of operation during the period of extension of the warranty.

For example, FIG. 11 shows the payment of an initial sum of 1000 US$ when purchasing a car, for extension of the warranty covering all hidden defects from two to five years.

The 1000 US$ are invested by the beneficiary of this initial payment, for example the car manufacturer or the agent, and for sake of simplification one assumes that the annual income of the investment is 10%.

At the end of the five year period, the capital is 1610.21 US$. If the client did not have to ask for damages at the end of the fifth year, a sum agreed in advance can be returned to him, for example the amount that was initially paid, i.e. 1000 US$.

The difference is used for example for payment of an insurance taken by the agent or the manufacturer for coverage of repair costs in case of defect of operation during the period of extension of the warranty.

The difference can also be used to pay directly at least part of the cost of repair, for example.

A sum greater than the sum initially paid by the client can be returned to him at the end of the contract for extension of the warranty, so as to make the method more attractive.

It is also possible to plan that at the end of the contract for extension of warranty the client will benefit of all or part of the initial sum paid when contracting the extension of warranty, indeed a greater sum, only at the condition to reinvest it at least partially in the buying of a new good from the same manufacturer or proposed by the same retailer or agent.

Naturally, the invention is not limited to the particular implementations described above.

The insurance policy can take on various forms, in particular it can be issued manually or by computer means only, without being printed on paper.

1/ An insurance method comprising the following steps:
establishing a contract between a client to be insured and an insurer ready to insure the client against possible claims, in which contract the client pays the insurer an initial sum covering at least the costs of insurance over a predetermined duration;
investing at least a portion of said initial sum so that the invested sum earns income; and
at the end of the said predetermined duration, reimbursing the client with a sum that is a function of the income earned by the investment made by the insurer and of the claims the insurer has had to indemnify during said predetermined duration.

2/ An insurance method according to claim 1, in which the sum reimbursed to the client corresponds, at least if there is no claim, at least to a major fraction of the income earned by the investment.

3/ An insurance method according to claim 2, in which the sum reimbursed to the client corresponds to all of the income earned by the investment.

4/ An insurance method according to claim 1, in which the investment is at a guaranteed minimum rate.

5/ An insurance method according to claim 1, in which the client is given the option of signing an addition to the contract while it is in force to enable the client to pay in an additional sum in the event of the insured risk increasing.

6/ An insurance method according to claim 1, in which the client is given the option of signing an addition to the contract while it is in force to enable the client to withdraw a sum in the event of the risk decreasing.

7/ An insurance method according to claim 1, in which the predetermined duration is longer than a determined duration set by legislation and enabling a tax advantage to be obtained.

8/ An insurance method according to claim 1, in which the reimbursement is made in the form of a lump sum.

9/ An insurance method according to claim 1, in which the reimbursement is made in the form of an annuity.

10/ An insurance method according to claim 1, in which the risks covered by the insurer concern property selected from the following list: vehicles, in particular cars, belonging to or used by the client; boats; other leisure property; real property belonging to the client and/or occupied by the client; professional property.

11/ An insurance method according to claim 1, in which the risks covered by the insurer are selected from the following list: defect of operation of a good, in particular a car, a domestic appliance or an industrial good; hidden defects.

12/ An insurance method according to claim 1, in which the initial sum paid by the client is greater than the total of the premiums paid in advance.

13/ An insurance method according to claim 1, characterized by the fact that the initial sum paid by the client is less than the total of the premiums due during the period of the contract, with at least a fraction of the earnings being used to pay at least a fraction of the premiums.

14/ A method according to claim 1, in which the duration of the contract is longer than one year.

15/ A method according to claim 1, characterized by the fact that the client is given the option of a plurality of contract durations, long duration contracts being more advantageous than short duration contracts in terms of the returns that can be obtained.

16/ A method according to claim 1, characterized by the fact that the insurer makes a present to the client of at least a portion of the costs of insurance in the absence of any claim.

17/ A method according to claim 1, in which the client is an insurance company seeking to reinsure with another insurance company.

18/ A method of insuring apparatus for locomotion on land, in the air, or at sea, the method comprising the following steps:
a) paying to the insurer in addition to the purchase or rental of the vehicle, a sum that is greater than or equal to the cost of insurance during a predetermined period;
b) investing at least a fraction of the sum paid by the client in an investment selected so that the income earned by the investment compensates for the cost of insurance in the absence of a claim; and
c) returning to the client, in the absence of a claim, and at the end of said predetermined period, at least said initial sum.

19/ A method according to claim 17, in which at least a portion of the initial sum paid by the client to the insurer is deducted from the amount of VAT due for the purchase of the vehicle, and in which at least a portion of the income earned by the investment is for obtaining an additional retirement pension.

20/ A method according to claim 20, in which the sum returned to the client is in the form of a coupon.

21/ A method according to claim 20, in which the sum returned to the client is in the form of an offer to extend the duration of the warranty for a new good to be purchased or rented.

22/ A system for issuing an insurance policy, the system comprising:
means for inputting the duration of the contracts
means for inputting the nature of the property to be insured;
means for calculating, where appropriate, the total of the premiums due during the duration of the contract, as a function of the nature of the property to be insured;
means for inputting the amount of an initial sum paid by a client;
means for delivering information relating to the earnings that can be made to the advantage of the client by an investment relating to at least a fraction of the initial sum and made by the insurer; and
means for printing an insurance policy including at least the duration of the contract, the amount of the initial sum paid by the client, the nature of the property, and information relating to the income that can be earned by said investment.

23/ An insurance policy comprising:
a contract duration;
the amount of an initial sum paid by the client;
the nature of the property insured; and
information relating to the income that can be earned to the benefit of the client by an investment relating to at least a fraction of the initial sum paid by the client.
